(19) United States
(12) Patent Application Publication
(10) Pub. No.: US 2004/0036681 A1
(43) Pub. Date: Feb. 26, 2004

(54) Identifying a form used for data input through stylus movement by means of a traced identifier pattern

(75) Inventors: Karen Ruth Kluttz, Raleigh, NC (US); David Andrew Sawin, Tucson, AZ (US); Ronald Alan Smith, Wake Forest, NC (US)

Correspondence Address: IBM Corporation, Personal and Printing Systems Group Legal Dept., Dept. 9CCA/Bldg. 002-2, P.O. Box 12195, Research Triangle Park, NC, 27709, US

(73) Assignee: International Business Machines Corporation, Armonk, NY

(21) Appl. No.: 10/227,322

(22) Filed: Aug. 23, 2002

(51) Int. Cl. G09G 5/00

(52) U.S. Cl. 345/173

(57) ABSTRACT

A computing system includes a user interface for supplying data by filling in a form with a marking stylus, with movement of the stylus across the paper being tracked to produce input data signals. The form includes a form identifying area in which form identifying information unique to the type of form is printed to be traced by the stylus, causing the system to recognize the type of form being filled in. After the type of form is recognized, input data from the form is stored for subsequent processing in locations determined according to the type of form. Marking within a termination area may be used to indicate completion of an individual form.

### BACKGROUND OF THE INVENTION

1. Field of the Invention

This invention relates to providing data input for a computing system by tracking movements of a stylus used to mark on a paper form, and, more particularly, to identifying a type of form being used for such data input, and to arranging data representing such input data for subsequent processing.

2. Background of the Invention

Several technologies have been developed for providing input data to a computing system as a user writes information on a paper document, with the input data being derived from movements of a pen used for writing. For example, a computing system sold as the IBM ThinkPad® TransNote® computer includes a digital notepad through which graphical inputs, including handwriting, are provided by writing on a sheet or pad of paper placed atop a digitizer pad using a special pen. The special pen includes both an ink system for writing on the paper and an electronic circuit for interacting with the digitizer pad. In general, a digitizer pad is a flat, rectangular device defining a rectangular space in which the point of a stylus may be placed, with the position of the stylus point being reported as a user input to a computing system. Most digitizer pads use a wire grid embedded within the surface of the pad, with associated electronics sending signals to the wires in the grid. The electronics circuits within the stylus, receive these signals though an antenna and return signals to the tablet, which are decoded to determine the location of the stylus. Alternately, the circuits within the stylus may simply emit signals that are picked up by the wires in the grid. Unlike a mouse or trackball, the digitizer pad and stylus form an absolute pointing device that produces a particular signal for each location at which the stylus is placed, regardless of the pattern through which it has been moved or the speed at which it is being moved.

Various aspects of this computing system are described in U.S. Pat. No. 6,362,440, which further describes a flexibly interfaceable portable computing device including a display coupled to a processor, which is coupled or selectively coupled to either or both or a keyboard and a recording unit. The display and the keyboard provide a first user interface to the processor. The recording unit is superimposable with a removable markable surface. A stylus allows user marking on the markable surface. The stylus provides a stroke signal and a stroke mark. The recording unit, the markable surface, and the stylus provide a second user interface to the processor. Optionally, the display also contributes to providing the second user interface to the processor. Switching among viewing modes for the display, and synchronization of information between the processor and a processor of the recording unit are also provided. A casing can enfold the display, the keyboard, and the recording unit to form a relatively slim profile. A portable computer system can have a display, a keyboard, and thick components enfolded and/or located within in overall thickness substantially equal to a sum of a first thickness for the display plus a second thickness for the keyboard, to present a slim profile.

Other aspects of the IBM ThinkPad® TransNote® computer are described in U.S. Pat. No. 6,259,043, which further describes the real time digitization of handwritten text and integration of digital recordation of handwritten text with traditional paper-based record making systems is achieved with a recording unit which may record a sequential data stream of strokes and associated events. The data stream may be stored in the apparatus and processed in accordance with various applications. Recordation of handwritten strokes may be accompanied by automatic detection and recordation of predefined events, and by user invoked generation of events. Recorded handwritten text may be processed to produce character strings or image data for text recorded in conjunction with predefined events.

In the apparatus described in U.S. Pat. No. 6,250,043, data is recorded through the detection of strokes and “events,” with an event being an occurrence having an assigned meaning. For example, a pen-down event indicates that the stylus has been brought into contact with the writing surface, while a pen-up event indicates that the stylus has been removed from contact with the writing surface. A stroke is defined as a series of pen coordinates, indicating the position of the pen or stylus over the digitizing pad between a pan-down event and a pen-up event. This apparatus also provides for several “soft buttons” comprising individual areas within the active area of the digitizer pad but outside the area covered by the paper on which markings are made. The system determines that a soft button event has occurred when stroke data is generated within the area of the soft button. The function of a soft button may be indicated with an icon or other legend.

Additionally in this apparatus, a new page event is used to identify a particular page of a writing medium, so that the user can switch pages at will, with recorded stroke data being associated with an identifier of a particular page. The new page event may be invoked by the user with a switch on the system, or with a soft button, with the system then causing the user to enter a new page identifier such as a page number. Then the digitizer tablet is enabled to provide inputs for the page that has been identified.

In other systems, the functions of the digitizer pad and stylus may be provided with markings printed on the paper to be used for writing, with these markings being read by an optical reading device within the pen. For example, U.S. Pat. No. 5,652,412 describes an information recording system including a writing paper having a writing surface and a prerecorded invisible pattern of pixels, preferably being printed with infrared reflective inks, associated with the writing surface. The system further includes a pen having a tip and including an instrument for writing on the writing surface and a detector for detecting the position of the tip on the writing surface by optically reading the pixels and obtaining position information when the tip is in contact with the surface. Preferably, the detector includes means for transmitting a light beam, including infrared radiation, to the surface of the paper, with the detection means being sensitive to changes in the infrared reflectance of the pattern of pixels, while the ink markings made by the instrument for writing relatively transparent to infrared radiation. The system further includes a recording unit coupled to the pen and responsive to the position information for electronically recording the position of the pen tip on the writing surface.

Each of the methods described above provides for capturing writing strokes within a computing system as a special pen is used to make markings on paper. A potential use of such methods lies in filling out forms that are standardized to the extent that a number of people must place the same types of information in locations on the form specified by indicia printed on the form. Particular advantages are expected to be gained by providing a method for generating computer readable signals as the forms are filled out without requiring the user to provide information through a keyboard. However, since the same system may be used to provide inputs through several different types of forms and forms including multiple pages, and since a system used in this way may also be used for different purposes, what is needed is a fast and reliable method for identifying the particular type of form, and the particular page within a multi-page form, being filled out by the user.

The method of generating pen location information based on a pattern of markings printed on the paper has the advantage of maintaining registration between the system used to determine the location of the pen being used to fill in the form and the indicia used to indicate where information should be written on the form. However, this method has the disadvantage of requiring a special paper including the markings used to determine pen location.

On the other hand, when the locating system used to determine the location of the pen is not part of the paper being written upon, what is needed is a fast and reliable method for determining the registration between this locating system and the paper, or, more specifically, the indicia printed on the paper for indicating where information should be written on the form. That is, when a digitizer pad is used, it is necessary to determine the registration between the paper and the digitizer pad. Additionally, since the paper document may slip on the digitizer pad during the process of filling in information, what is needed is a way of determining, at the end of this process, whether such slippage has occurred.

U.S. Pat. No. 5,434,371 describes a handwriting implement including a writing tip for marking the paper and accelerometer sensor for sensing movement of the writing tip. Output signals from the accelerometer sensor are processed to derive the location of the writing tip as it is moved to write a line. This process is begun by writing a special initialization character, such as an inverted “L,” that is recognized as such by a character recognition subroutine executing within a computing system. After the line is written, a stop character, which may be the initialization character or another special character is written to stop the process of recording signals representing the line being written. Thus, while one or more special characters starts and stops this process, a special character is not provided for determining a type of document or form, or for providing a reference to a particular location on the paper document.

In the methods described above, the written information is made visible by writing on the paper document with ink. Alternately, as described, for example, in U.S. Pat. No. 5,049,862, a paper document can be used with a conventional stylus, lacking a writing tip to mark the document, and with a conventional digitizer pad, with information derived from the stylus movement being used to write corresponding data to a display screen. The display screen provides a visual indication of the data as it is being written. Still, what is needed is a method for readily identifying which of several types of forms is being used.

U.S. Pat. No. 5,243,149 describes a notepad providing an interface to a computer for paper based information. The notepad has a form factor similar to a clipboard, with the board portion including a digitizing tablet and the clip portion including an optical scanner. A battery-powered embedded processor and associated peripherals for capturing and storing including at least scanning information, digitized stylus information, and audio annotation. Work on an individual document begins with scanning the document as it is mounted on the digitizer. A bar code printed near the top of the document is scanned, with its data being used to prepare a file header for data reflecting that page. What is needed is a convenient way to provide data identifying a type of form without requiring a document scanning process or the presence of a scanner in the computer input device.

U.S. Pat. No. 5,528,154 describes a method and apparatus for electronically identifying a page. Each page has a surface conductive trace that is coupled to an electronic circuit to measure the conductivity of the trace. The primary purpose of the conductive trace is to provide an identification for the page. In a preferred embodiment, each sheet has a surface conductive trace, which may be a line printed with conductive ink, close to one of its edges. The entire stack of paper is glued together along an edge, with the bottom sheet sitting on a sheet of cardboard, as in many conventional notepads. The edge is in proximity to all the conductive traces, with edge conductive traces coupling the surface traces to conductive patches on the bottom of the cardboard. Each trace is connected to two or more edge conductive traces that end in two or more corresponding board conducive patches. The bottom of the cardboard has a row of conductive patches close to the specific edge of the pad. The pad is clamped to a clipboard that has a similar row of connector conductive patches, each of which touches a corresponding patch on the cardboard. Through the connector patches, electronics in the clipboard checks the conductivity of each trace. After the user writes on one of the pages, he tears it off the stack, breaking the conductive trace in that sheet, so that the change in conductivity provides an identification of the sheet that has been removed. In this way, each sheet of paper is automatically identified by a process that is transparent to the user. However, what is still needed is a way of identifying an individual type of form that is not bound into a paper pad, and a way of effecting such an identification without a need to print or sense conductive traces.

### SUMMARY OF THE INVENTION

In accordance with a first aspect of the invention, a method for selecting a format for placement of data derived from the location sensing means is provided in a computer system having a user interface including a stylus for marking surfaces of markable media and location sensing means for detecting locations of the stylus as the stylus is moved along a surface of the markable media. The method includes sensing a format identifying pattern of movement of the stylus along a markable medium within a format identifying area of the markable medium; generating a format identifying data pattern representing the format identifying pattern of movement of the stylus; and searching a data structure including a plurality of format identifying data patterns and formatting data associated with each of the format identifying data patterns for a match between the format identifying data pattern representing the pattern of movement of the stylus and a format identifying data pattern within the plurality of format identifying data patterns.

The markable medium is, for example, a printed paper form including visible indicia forming a visible pattern within said format identifying area, in which tracing said visible pattern with said stylus moves said stylus in said format identifying pattern of movement of said stylus.

The location sensing means includes, for example, a digitizer pad extending under the markable medium to provide signals representing the movement of the stylus on the medium, with the stylus including circuits interacting with the digitizer pad and a supply of ink for marking on the medium.

Alternately, the location sensing means includes markings on an upper surface of the markable medium, with the stylus including a camera for sensing these markings, circuits for transmitting location information based on these markings, and a supply of ink for marking on the medium.

In accordance with another aspect of the invention, a method for processing input data provided through such a computer system user interface is provided. The method includes sensing a plurality of input patterns of movement of the stylus along the markable medium in an area outside a termination identifying area of the markable medium; generating a data input structure representing each of the input patterns of movement of the stylus; storing each the data input structure; sensing a termination pattern of movement of the stylus along the markable medium in the termination identifying area of the markable medium; and after sensing the termination pattern of movement of the stylus along the markable medium, transmitting each the data input structure for processing.

Different types of forms have different ranges or fields in which data is provided to be used during subsequent processing of information. For example, the user may supply his name in one field of one form, with data from a number of forms being subsequently processed by arrangement in an alphabetical order of user names, allows access to the data by name. Therefore, the data provided by the user is arranged within fields in a format arranged according to the type of form. This arrangement may take place as the form is being filled out or after it has been completely filled out.

### BRIEF DESCRIPTION OF THE DRAWINGS

FIG. 1 is a perspective view of a computing system providing a paper-based input in which the invention is practiced;

FIG. 2 is a block diagram of components within the computing system of FIG. 1;

FIG. 3 is a pictographic view of an input form data structure stored within the computing system of FIG. 1;

FIG. 4 is a pictographic view of an output form data structure stored within the computing system of FIG. 1;

FIG. 5 is a flow chart of a first version of a form completion subroutine executing in the computing system of FIG. 1 in accordance with the present invention, with FIG. 4A being an upper portion of FIG. 4, and with FIG. 4B being a lower portion thereof;

FIG. 6 is a perspective view of an alternative computing system providing a paper-based input in which the invention is practiced;

FIG. 7 is a flow chart showing the flow of data during processing in accordance with the present invention; and

FIG. 8 is a flow chart of an alternative version of a form completion subroutine executing in the computing system of FIG. 1 or of FIG. 6 in accordance with an alternative version of the present invention.

### DETAILED DESCRIPTION OF THE INVENTION

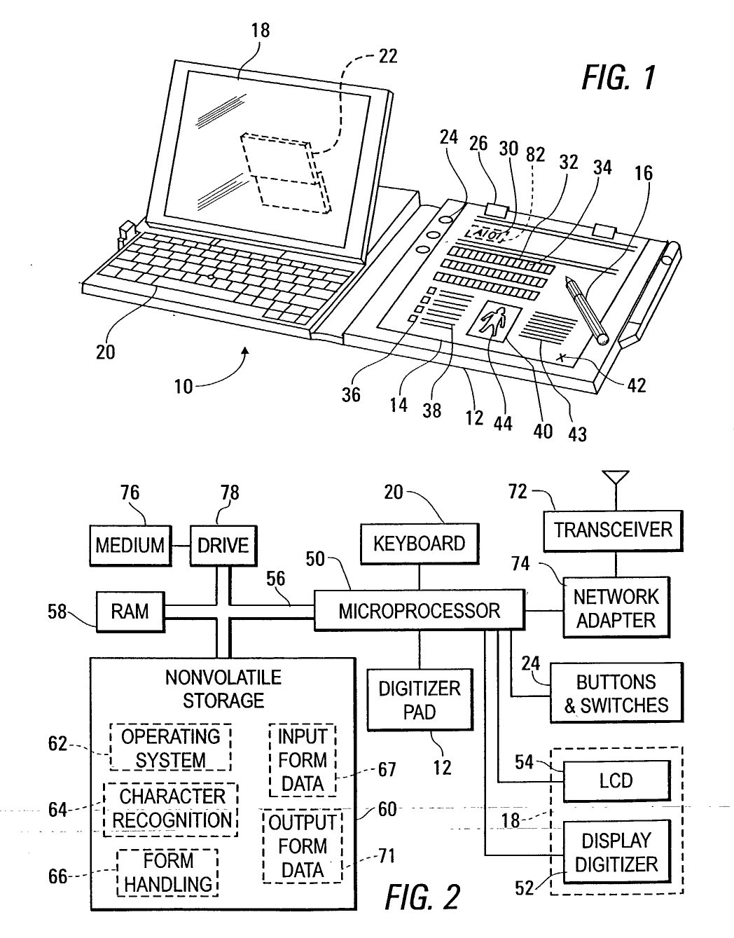

FIG. 1 is a perspective view of a computing system 10 providing a paper based input through a digitizer pad 12 for practicing the invention, with a printed form 14 in place on the digitizer pad 12. The digitizer pad 12 provides an active area through which movements of the stylus 16 to write on the form 14 are recorded. The stylus 16 includes both an ink supply to facilitate marking on the form 14 and a radio transmitter to interact with electronic circuits within the digitizer pad 12. The computing system 10 also includes a display 18 and a keyboard 20. The display 18 includes an LCD screen for output and a display digitizer pad for input. Thus, inputs to the computing system 10 may be provided by writing on the display 18 with a stylus, by writing on a form 14 to provide signals through the digitizer pad 12, or by typing characters through the keyboard 20. The LCD screen of the display 18 provides outputs from the computing system 10. The display screen 18 is held in the position shown by means of a support mechanism 22 and may alternately be lowered to cover the keyboard 20 in a flattened condition, with all user inputs being provided through the digitizer pad 12 and through a number of additional buttons and switches 24. The computing system 10 may also include a pair of clamps 26 or other means to keep the form 14 properly aligned on the digitizer pad 12.

For example, the computing system 10 is the system sold as the IBM ThinkPad® TransNote® computer, programmed in accordance with the invention to execute a program for the entry of data from paper forms and storing, further in accordance with the invention, with various aspects of the computing system 10 being described in U.S. Pat. Nos. 6,259,043 and 6,362,440, both of which are incorporated herein by reference.

The printed form 14 includes a number of printed indicia used to provide information to the user and to guide the user in filling out the form with the stylus 16. These printed indicia include an identifier 30 associated with the particular type of form 14 and a number of data fields 32 that may be further divided into character boxes 34, in which individual characters are to be drawn using the stylus 16. The term “character,” as used herein, is understood to mean an alphabetic or numeric symbol or another type of symbol that can typically be produced using a type font, such as the pound sign (#). Check boxes 36 may be checked off to select items from a list 38. The printed form 14 may also include a drawing area 40 in which the user may draw generalized shapes that are recorded by the computing system 10.

According to a preferred version of the present invention, the printed form 14 also includes a termination marking 42 that is traced by the user to indicate that he is finished filling out an individual form. For example, the computing system 10, upon recognizing that this form has been completed, may store input data provided by the user in a location reserved for data from completed forms, or the computing system 10 may cause this data to be transmitted to another system. The location of the stroke(s) provided by the user as the termination marking is traced may be used, along with the location of strokes provided as the identifier 30 is traced, to determine the registration position of the form 14 relative to the digitizer pad 12.

Preferably, the user is provided with an ability to go from one form to another and to return to complete a partially filled-out form. For example, the user may simply remove the partially filled-out form from the digitizer pad 12 without tracing the termination marking, replace this form 14 with a new form 14, and trace the identifier 30 of the new form 14 to begin the process of entering data on the new form 14. Later, the user may return the partially filled-out form 14 to the digitizer pad 12 and retrace its identifier to return to the process of filling out this form 14.

In general, the printed indicia of the form 14 also include descriptive data 43 providing instructions describing how the form 14 should be filled out.

For example, if the printed form 14 has been developed for providing data in a doctor's office, the data fields 32 may be used to record name, address, and insurance information, while the check boxes 36 are used to provide medical history information relative to problems described in the list 38, and while the user is additionally asked to circle areas on a FIG. 44 printed in the area 40, indicating where the pain or other present problem is occurring.

FIG. 2 is a block diagram of the computer system 10, which includes a microprocessor 50 connected to receive inputs from the keyboard 20, the paper-based input digitizer 12, a digitizer 52 within the display 18, and the buttons and switches 24. The microprocessor 50 is also connected to provide outputs through an LCD screen 54 within the display 18. The microprocessor 50 is connected through a bus structure 56 to read data and program instructions from a RAM (random access memory) 58 and from nonvolatile storage 60, and to write data to the RAM 58 and nonvolatile storage 60. Nonvolatile storage 60 may include one or more flash memory cards; magnetic storage, such as a hard disk drive; and a read-only memory chip storing a BIOS (basic input/output system) program.

Referring to FIGS. 1 and 2, during typical operation of the computer system 10, subroutines of programs stored within nonvolatile storage 60 are loaded into RAM 58 for execution in the microprocessor 50. Nonvolatile storage 60 stores an operating system 62, such as Microsoft Windows® 2000, a characterization recognition program 64 that recognizes characters from combinations of strokes detected by either the digitizer pad 12 or the display digitizer 52; and a form handling program 66 that provides for the user input of data from a number of paper-based forms in accordance with the invention. Nonvolatile storage 60 additionally stores an input form data structure 67, including entries for each of a number of different forms.

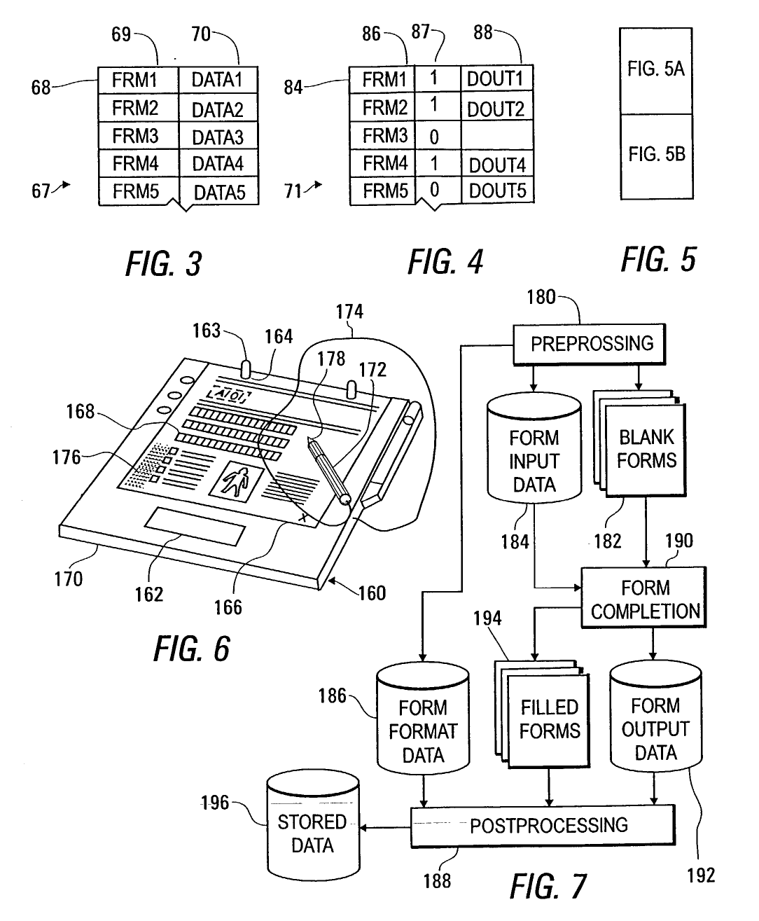

FIG. 3 is a pictographic view of the input form data structure 67, which includes an entry 68 for each type of form that can be accessed through the computer system 10 in accordance with the first embodiment of the invention. Each of these entries 68 includes a first field 69, storing a combination of characters uniquely identifying the type of form, and a second field 70, storing data providing a format into which representations of the data being entered into the computing system by means of strokes will be entered for subsequent processing and for the particular type of form 14 being filled out and further describing markings that are to be displayed on the display 18 as this particular type of form is being filled in by the user. For example, the data stored in the second field 70 may provide for a number of character boxes in a name field, with codes for alphanumeric characters being stored at locations within a name field for subsequent processing. Such subsequent processing may, for example, arrange data generated from a number of forms 14 in alphabetic order of the names within the name fields, for storage and convenient retrieval.

Referring again to FIGS. 1 and 2, on a particular type of form, locations for data entry are, for example, areas within the active area of the digitizer pad 12 corresponding to the data fields 32, the character boxes 34, check boxes 36, and the-area 40 which has been reserved for non-alphanumeric data entry. Furthermore, nonvolatile storage 60 includes an output form data structure 71 storing data that has been recorded on various forms by users.

Data stored within the computer system 10 is preferably communicated to an external device through a transceiver 72, which is connected to the microprocessor 50 through a radio enabled network adapter 74. Alternately, output data may be written on a removable medium 76, such as a magnetic diskette, through a drive unit 78 connected to the bus 56. Both program instructions and data may be loaded into the computing system 10 through a removable computer readable medium 76, or through the transceiver 72 in the form of a computer data signal embodied in a carrier wave.

According to a preferred version of the invention, the process of filling out a form 14 placed atop the digitizer pad 12 begins as the user traces the identifier 30, with this operation being sensed by the computing system 10 as a series of strokes within a form identifying area 82 of the underlying digitizer pad 12 used only for this purpose when the program for data entry from forms is executing within the computing system 10. Thus, a combination of strokes occurring within this identifying area is assumed to precede the entry of data on a new or different form. After data is entered in this area, it is compared with a number of possible versions of such data. If a match is found, a form associated with the version of this data is chosen. Then the data fields 32, character boxes 34, and check boxes 36 of this particular form are displayed on the display screen 18. Other data from the chosen form 14, such as descriptive material 43 and the FIG. 44 may also be displayed on the display 18. As the user proceeds to fill the form by writing characters in the data fields 32, and character boxes 34, corresponding characters are displayed in corresponding locations on the display 18. When the user marks one of the check boxes 35, a check mark is displayed in a corresponding location on the display 18.

In accordance with one version of the invention, when a new identifier 30 is traced from a form 14 in the form identifying area 82 of the digitizer pad 12, data from the form previously displayed is written to the output form data structure 71, and the data describing the net form is loaded from the input form data structure 68, to be displayed on the display 18. The user can return to a previously filled form to make changes or record additional data by placing the form on the digitizer pad 12, and by then retracing the form identifier 30. This action causes the input data from the form, loaded from the input form data structure 68, to be displayed on the display 18, along with the previously-recorded output data from the form, loaded from the output form data structure 71.

FIG. 4 is a pictographic view of the output form data structure 71, which includes an entry 84 for each type of form that can be accessed through the computer system 10. Each of these entries 84 includes a first field 86, storing a combination of characters uniquely identifying the type of form, a second field 87, storing a value indicating whether the process of filling out the form has been completed, and a third field storing the data, if any, provided as inputs by the user during the process of filling out the form identified in the first field 86. Preferably, the value in the second field 87 is set when it is determined that the user has traced the termination mark 42 of the form 14. After this value is set within an entry 84, the data in the third field 88 of this entry 84 is available for transfer to another computing system (not shown) to be archived or to be further processing as required.

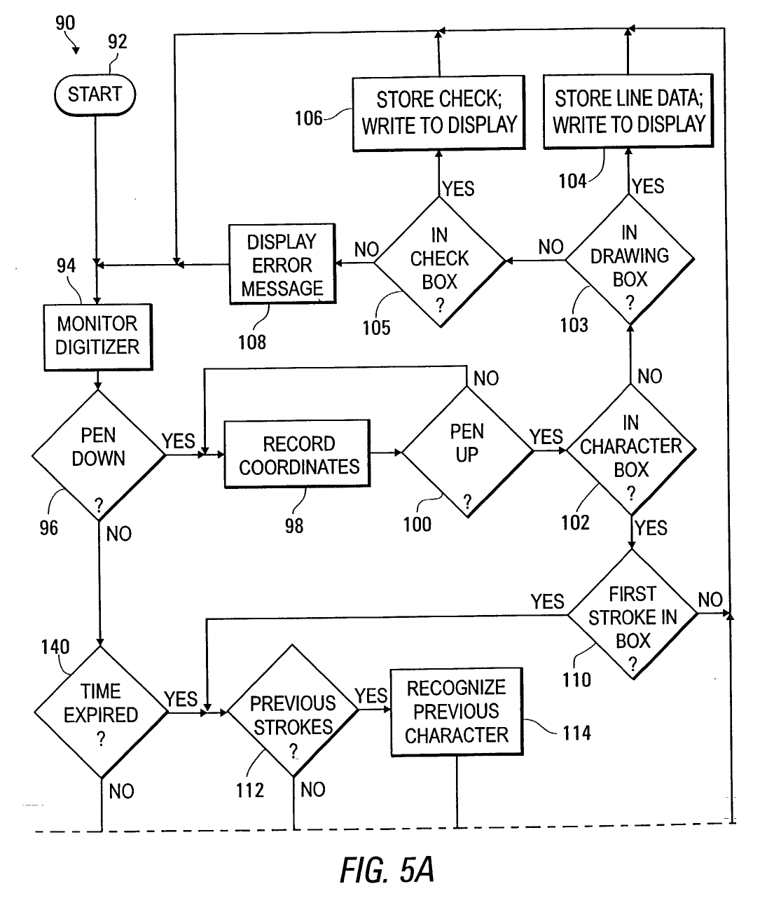

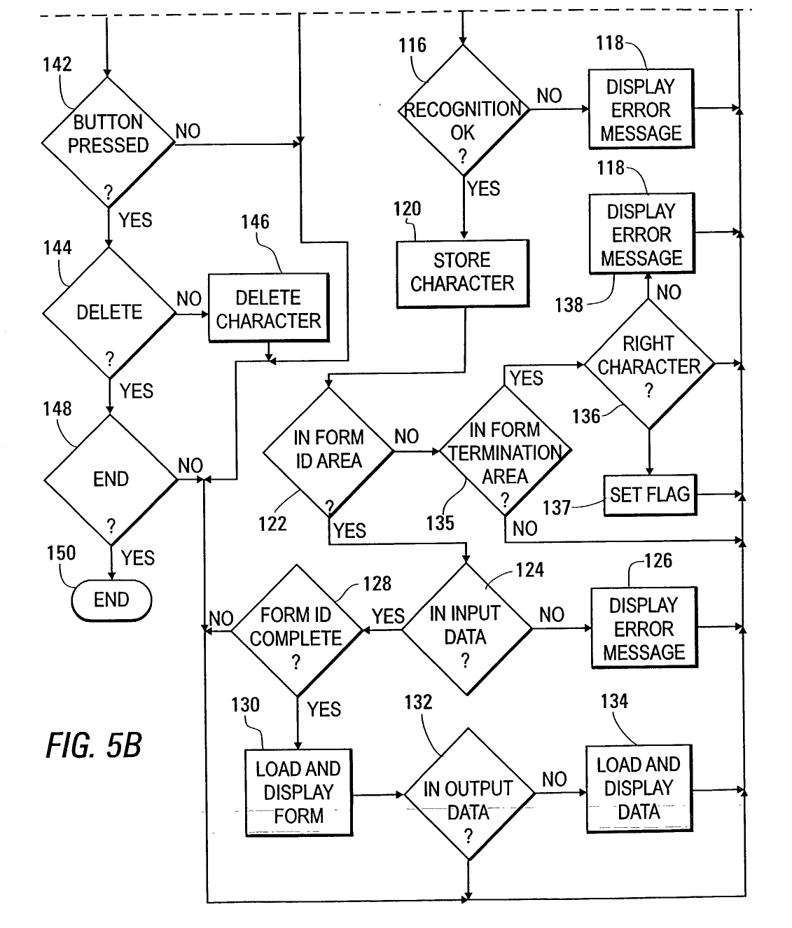

FIG. 5 is a flow chart of a form completion subroutine 90 executing within the computing system 10 in accordance with the invention, as a portion of the form handling program 66. FIG. 5 is divided into an upper portion, FIG. 5A, and a lower portion, FIG. 5B.

Referring to FIGS. 1-5, the form completion subroutine 90 starts in step 92 and begins monitoring the digitizer pad 12 in step 94. When the user moves the stylus 16 into contact with the form 14 atop the digitizer pad 12, a PEN DOWN signal from the digitizer pad 12 is recognized in step 96, causing the system to begin recording coordinates of pan movement in step 98. This process continues, with horizontal and vertical coordinates from the digitizer pad 12 being recorded to establish the path of movement of the stylus 16 along the form 14, until the user removes the stylus 16 from the form 14, causing the digitizer pad 12 to provide a PEN UP signal, recognized in step 100.

After recognizing the PEN UP signal in step 100, the system proceeds to step 102 to determine whether the line for which coordinates have been recorded in step 98 is within a character box 34, which has been reserved for markings used to generate an character. If it is determined in step 102 that the line has not been recorded in a character box 34, a determination is made in step 103 of whether the coordinates indicate that the mark has been recorded in a drawing box 40, which is reserved for compiling data representing general drawing forms, instead of characters. Thus, if it is determined in step 103 that the mark has been made in a drawing box 40, coordinate data describing the line is stored in step 106.

Preferably, an image of the form being filled out is displayed on the display 18, being updated as data is filled in by the user on the form 14 placed atop the digitizer pad 12. Thus, when data describing the line added by the user is stored in step 104, this data is also written to the display 18, updating the image displayed thereon.

If it is determined in steps 102, 103 that the line is not in either a character box 34 or a drawing box 40, a determination is made in step 105 of whether the line has been entered in a check box 36. If it has, in step 106 a code for a check symbol is stored in a corresponding location, and a check symbol is displayed in a corresponding position on the display 18. If a determination is made in step 105 that the line has not been entered in a check box 36, an error message is displayed in step 108 on the display 18, indicating that the mark has been put in the wrong place, and the system returns to step 94 to continue monitoring the output of the digitizer pad 12.

On the other hand, if a determination is made in step 102 that the mark has been made in a character box 34, a determination is made in step 110 of whether the stroke for which coordinates have most recently been recorded in step 98 is the first stroke in this particular character box 34. If it is not the first stroke in this box, the system returns from step 110 to step 94 to continue monitoring the output of the digitizer pad 12, with the recorded coordinates being held. If it is the first stroke in this particular character box 34, the system proceeds to step 1 12, in which a determination is made of whether previous strokes, made in another character box, have been stored without being recognized as an character. That is, an assumption is made that, if the user has moved on to another character box 14, the character in the previous character box 34 is considered to have been completed, so an attempt is made in step 114 to recognize an character within the previous character box 34. If such an attempt to recognize a previously-formed character is not successful, as determined in step 116, an error message is presented in step 118, and the system returns to step 94 to monitor the output of digitizer pad 12. For example, the user may from this point delete the previous character or complete it by adding one or more strokes.

If it is determined in step 116 that the previous character has been successfully recognized as an character in step 114, this code for this character is stored in memory and displayed in a corresponding place on the display 18, in step 120, before the system proceeds to step 122, in which a determination is made of whether the previous character is in the particular area 82 reserved for characters to be traced by the user to identify the particular form being filled out. If the previous character is determined in step 122 to be in this area 82, the system proceeds to begin a process of comparing the character or characters traced within this area 82 of the form 14 with the possible combinations of such characters, which are stored in the first field 69 within the input form data structure 67. For example, if four characters are used to identify each of the forms which may be used with the computing system 10, there are from one to four of such characters recognized and stored in previous passes through step 120 at this time. First, in step 124, a determination is made of whether these stored characters match a first portion of one of the possible combinations of characters in the first field 69 of the input form data structure 67. If they do not, the, an error message is displayed in step 126, and the system returns to step 94 to continue monitoring the output of the digitizer pad 12. From this point, the user may, for example, delete one of the stored characters or modify it by adding one or more strokes.

If it is determined in step 124 that these stored characters match one or more of the possible combinations of characters in the first field 69 of the input form data structure 67, a determination is next made in step 128 of whether one of these possible combinations of characters has been completed. If it has not, the system returns to step 94 to monitor the output of the digitizer pad 12, giving the user a chance to complete the entry the form-identifying characters by tracing remaining characters printed on the form 14.

If it is determined in step 128 that these stored characters are listed in the first field 69 of the input form data structure 67 as identifying a form, the input data from the second field 70 of the entry 68 in which the matching form-identifying characters are found is loaded into storage 58 and displayed on the display 18 in step 130. This data causes various markings providing information and showing the locations of data fields 32, character boxes 34, check boxes 38, and picture boxes 44 to be shown on the display 18. Then, the system proceeds to step 132, in which a determination is made of whether data is stored within the output form data structure 71 for the form corresponding to the entry 68 in which the matching form-identifying characters are found. If such data is stored, it is loaded into storage 58 and displayed on the display 18 in step 134. This process allows the user to continue filling out a form 14 for which he has previously provided data by returning the form to its position atop the digitizer pad 12 and by retracing the identifier 30 for the form. After such data is displayed in step 134, or after a determination is made in step 132 that such data has not been stored within the output form data structure 71, the system returns to step 94 to continue monitoring the output of the digitizer pad 12.

If it is determined in step 122 that the previous character is not in the area 82 reserved for characters to be traced by the user to identify the particular form being filled out, the system proceeds to step 135, in which a determination is made of whether the previous character is in the area reserved for tracing the termination character 42. If it is in this area, the system proceeds step 136 to determine whether the character has been recognized as the correct termination character 42. If it has been recognized as the correct character, a flag value is written in step 137 to the second field 87 of the entry 84 within the output form data structure 71, for the form now being filled out, indicating that the user has completed filling out this form, and making the output data stored in the third field 88 of this entry 84 available for transfer to another system for archival storage or for further processing. If it is determined in step 136 that the correct termination character 42 has not been recognized, an error message is displayed in step 138, as the system returns to step 94 continue monitoring the output of the digitizer pad 12. This method reduces the likelihood that the process of providing data by filling out a form will be inadvertently terminated, for example, by mistakenly checking the area of the termination character 42.

In accordance with a preferred version of the invention, the process of monitoring the output of the digitizer pad 12 includes a process of determining if a PEN DOWN signal has occurred in step 96, as described in detail above, along with determining, in step 140, whether a predetermined time has elapsed since the last action of the user, and furthermore, along with determining, in step 142, whether the user has depressed one of the control buttons 24.

Thus, the process of recognizing an character from the strokes made in a character box 34 is begun either when the user moves on to make a stroke in another character box 34, as explained above, or when the user allows a predetermined time to expire since his last action, as determined in step 140, causing the system to proceed to step 112, in which a determination is made of whether previous strokes, made in a character box have been stored without being recognized as an character. The system then proceeds from this step 112 as described above. If it is determined in step 140 that the predetermined time has not expired, the system proceeds to step 142 to determine whether the user has depressed one of the control buttons 24. If a button has not been depressed, the system then returns to step 94 to continue monitoring the output of the digitizer pad 12.

If it is determined in step 142 that a button has been depressed, a determination is then made in step 144 of whether the DELETE button has been depressed. If it has, the character or strokes in a character box through which the most recent input was made using the stylus 16 is deleted in step 146. Then the system returns to step 94 to continue monitoring the output of the digitizer pad 14. This method is thus used to delete strokes that cannot be recognized as an character or to delete a previously recognized character that is to be changed.

If it is determined in step 144 that the DELETE button has not been depressed, the system proceeds to step 148 to determine whether the END button has been depressed. The END button is used to end a session by a particular user after he has filled out one or more different forms. If it is determined in step 144 that the END button has not been depressed, it is known, for example, that a button that has not been defined for use in this subroutine has been depressed, so the system returns to step 94 to continue monitoring the output of the digitizer pad 12. If it is determined in step 144 that the END button has indeed been depressed, the system proceeds to step 150, in which the form data input subroutine 90 is ended.

Thus, in accordance with the first embodiment of the invention, after the identifier of a particular type of form is recognized as being completed in step 128, each representation of a character is stored in step 120 within a character box located according to the format data associated with the form and stored within the second field 70 of the input form data structure 67, and within the entry 68 thereof found by matching the identifier with the first field 69 of this data structure 67.

For example, when the form completion subroutine 90 is ended, the system returns to the main form-handling program 66. At this point, the data stored in the output form data structure 71 may be transferred by means of a radio signal from the transceiver 72 to a central computer system (not shown) in which data supplied by various users is accumulated. Alternately, data may be retained within the output form data structure 71 until several different users have caused several sets of data to be stored therein, before the several sets of data are transferred to the central computer system.

While it is understood that many forms have more than one page, it is understood that a multi-page form may be treated by the computing system 10 as a number of single-page forms, with each page having its own identifier 30 to be traced. For example, identifiers of the multiple pages of such a form may differ only in the last one or two digits, being presented in a way causing the user to treat the multiple pages as parts of the same form.

FIG. 6 is a perspective view of an alternative computing system 160 providing a paper-based input in which the invention is practiced. In this alternative system 160, a relatively small LED display screen 162 is provided in place of the large display 18 of the computing system discussed above, and the keyboard 20 of the computing system described above is eliminated. While the size of the display screen 162 prevents the display of a full page of form data in the manner previously described, characters are shown on the display screen 162 to form words or phrases indicating the results of the character recognition process of step 114 (shown in FIG. 5), so that the user can determine whether characters have been recognized in the manner he intended. While the smaller display screen 162 lacks an underlying digitizer, like the display digitizer 52 (shown in FIG. 2), this feature is not needed in a device having a paper-based input. Additionally, the keyboard 20 is not required for operation of the computing system in a manner using a paper-based input.

Additionally, the example of FIG. 6 shows optional positive locating features, in the form of pins 163 extending through holes 164 in the form document 166, to hold the document 166 accurately and reliably in place so that the features 168 printed on the document 166 correspond accurately to locations within a digitizer pad underlying the document 166 within a housing 170. The housing 170 also includes, for example, the various elements shown in FIG. 2, except for the display digitizer 52 and the keyboard 20, with the smaller display 162 being used in place of the display 18.

In accordance with a version of the invention, a form completion subroutine executes within the alternate computer system 170 in the manner described above in reference to FIG. 5, except that the display 162 is used in a somewhat more limited way. For example, markings may be shown in the display 162 only to duplicate the markings placed on the form by the user in the immediate area of the form adjacent the stylus, with such markings being displayed in the form of strokes or in the form of characters recognized from combinations of strokes.

The example of FIG. 6 also shows an optional arrangement in which a stylus 172 is connected to the housing 170 by means of a cable 174 including a number of insulated conductors carrying electrical signals between circuits within the stylus 172 and circuits within the housing 170.

While the invention has been described as implemented using a stylus to write on a form placed atop a digitizer pad, it is understood that a second embodiment of the invention may be implemented using a stylus to write on a paper having markings that are sensed within the stylus to provide signals indicating the position of the stylus on the sheet of paper as the stylus is used for writing. A system using this type of stylus and paper is described, for example, in U.S. Pat. No. 5,652,412, the disclosure of which is incorporated herein by reference.

For example, this second embodiment of the invention may be implemented in apparatus as shown in FIG. 6, with markings 176 being printed to extend across the front surface of the form 166, to be visible to a camera unit within the tip 178 of the stylus 172. As described in detail in U.S. Pat. No. 5,652,412, these markings may include lines extending in horizontal and vertical directions, being formed of inks reflecting infrared energy and providing different shades to encode position information. Preferably, the user readable markings 168 printed on the form 166 and the markings placed on the form by the user with the stylus 172 are substantially transparent to infrared radiation. Preferably, as further described in detail in U.S. Pat. No. 5,652,412, the tip 178 of the stylus 172 includes both a suitable light source for illuminating the markings 168 as the stylus 172 is used to write on the form 166 and a camera providing signals used to determine the location of the stylus 172 on the form 166 during the writing process.

Operation of this second embodiment of the invention proceeds as described above in reference to FIGS. 2, 3 and 6, except that outputs from the stylus 172 are monitored in place of outputs from the digitizer pad 12 to determine the location of the stylus 172.

FIG. 7 is a flow chart showing the flow of data during processing in accordance with the present invention. The processing begins with preprocessing 180, in which blank forms 182 are printed, so that each form has printed indicia as described above in reference to FIG. 1, such as a form identifier 30, character boxes 34, descriptive material 43, and the termination marking 42. Preprocessing 180 also writes form input data 184 to a computer readable medium that is loaded to the computing system 10 or 160 for storage within the input form data structure 164. The transfer of the input data 184 is accomplished, for example, by transmitting data through the transceiver 72 of the computing system 10 or 160, or by recording data on a removable medium 76 that is read by the drive 78 of the computing system 10 or 160. Optionally, preprocessing 180 also causes form format data 186 to be generated for use in postprocessing 188, with this data describing, for example, the organization of data associated with each of the forms described in the form input data 184 into fields for subsequent postprocessing.

The form completion process 190, occurring within the computing system 10 or 160 as described above, produces form output data 192, which is stored in the output form data structure 71 as the forms are filled in during form completion, and which is then transmitted to a central computer system (not show) for postprocessing 186. Preferably, the filled forms 194 that are produced by the user during form completion 190 are also carried to the area in which postprocessing occurs, so that they can be used if there is a problem understanding or interpreting a portion of the form output data 192. Postprocessing 188 then produces stored data files 196, containing the form output data 192, recorded in fields defined by the form format data 186. As required by an individual application, various additional types of reports are generated, and data is displayed.

The transfer of form format data 186 from preprocessing 180 to postprocessing 188 may not be required, as such data may be instead transferred a s part of the form output data 192 from the form completion process 190, having been received as a part of the form input data 184.

The preceding discussion has described examples of the invention operating on a character-by-character basis, with each character being entered by the user in a specific individual character box defined both by printed markings on the form and by the assignment of corresponding locations within the digitizer pad 12 of the first embodiment or the pattern 176 of the second embodiment. While such a method simplifies the problems associated with the recognition of individual characters, therefore optimizing the reliability of character recognition, less restrictive methods for characters hand lettered on a digitizer pad have been developed and may be used in the implementation of the invention.

For example, a third embodiment of the invention is performed in a system as described above in reference to FIGS. 1 and 2, with the microprocessor 50 being programmed to generate strings of characters based on operator inputs including strokes performed with the stylus 16 or 172. The generation of such strings of characters is described, for example, in U.S. Pat. No. 6,259,043.

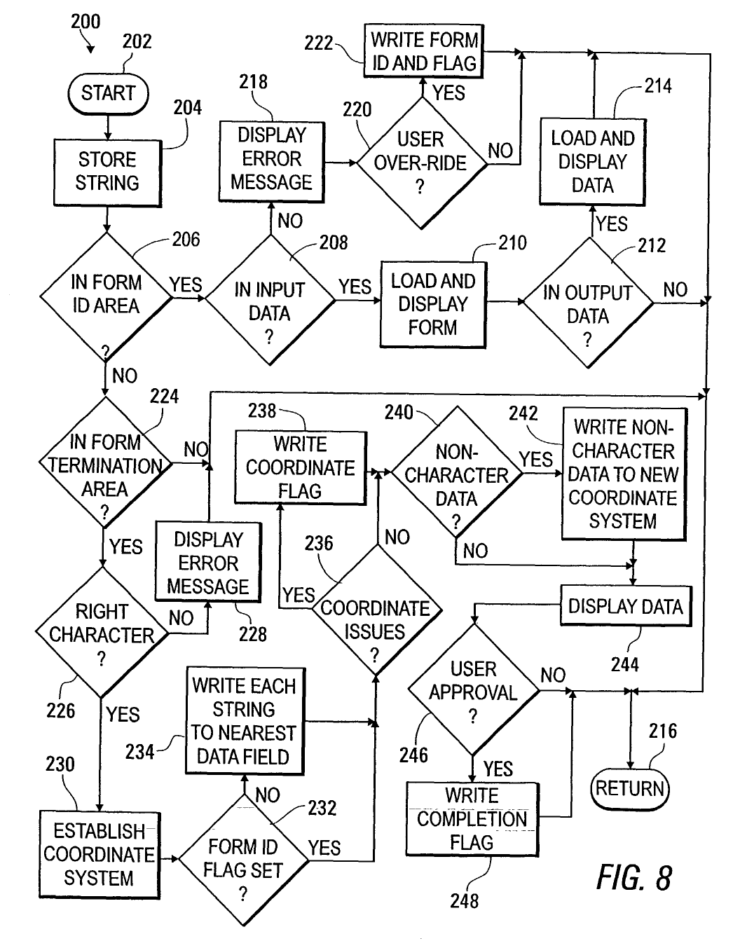

FIG.8 is a flow chart of an alternative form completion subroutine 200, executing within the microprocessor 50 in accordance with the third embodiment of the invention. Referring to FIGS. 1-4 and 8, this subroutine 200 is started in step 202, having been called by a program generating strings of characters in response to the completion of the generation of such a string. For example, a check mark in a column of locations to be checked may be considered an individual character string. Then, in step 204, this string is stored, including data describing its content as a sequence of characters, and additional data describing its location on the digitizer pad 12. Next, in step 206, a determination is made of whether the string stored in step 204 is stored within the form identification area 82 of the digitizer pad 12. If it is, the system proceeds to step 208, in which a further determination is made of whether the character string stored in step 204 is present within one of the entries within the first field 69 of an entry 68 within the input data structure 67. If it is, one of the forms set up for use within the computing system 10 has been correctly identified, so the corresponding input data from the second field 70 of this entry 68 is loaded and displayed in the display screen 18 in step 210.

Then, in step 212, a determination is made of whether output data for the corresponding form has been stored in the third field 88 of the output form data structure 71. If it has, the output data for the corresponding entry 84 is loaded into storage and displayed in step 214, so that the user can continue filling out a form for which this process has been partly completed. Whether or not such output data is found, the system proceeds to return to the calling program in step 216 so that the user can fill out the newly displayed form, with strings of characters being generated by the calling program. On the other hand, if it is determined in step 208 that the character string stored in step 204 is not present in one of the entries within the first field 69 of an entry 68 within the input data structure 67, an error message is displayed on the display 18 in step 218, indicating that the traced characters cannot be found.

Preferably, a provision is made within the subroutine 200 for allowing the user to override the determination in step 218 that the character string cannot be found in the input data structure 67. Referring additionally to FIG. 7, this provision allows use of a new form, which is not among the blank forms 182 generated during preprocessing 180, as input data 184 stored within the input form data structure 67 was also generated. For example, the user is allowed to override the system by pressing one of the buttons 24 or to indicate that he is not overriding the system by pressing another of the buttons 24. If the user overrides the error condition as determined in step 220, having realized that he has traced the form identifier 30 correctly, the system writes an entry 84 to the output data structure 67 including the character string identifying the form in the first field 86 and a form identifying flag bit within the flag field 67. Since there is no corresponding entry 68 in the input form data structure 67, and therefore no input data in the second field 70, there is no way to display such a structure on the display 18, which is then used only to show stroke information and recognized characters provided as input from the user. During subsequent postprocessing 188, the form identifying flag bit stored within the output data structure 71 indicates that special processing may be required for form data lacking a corresponding entry within the form format data 186 previously provided to postprocessing 188. After the flag bit is written in step 222, the system returns to the calling program in step 216, so that the user can continue filling out the new form.

On the other hand, if the user realizes that the characters he has traced have not been recognized correctly as the form identifier 30, he does not override the system, causing the system to proceed from step 220 to step 216, in which the system returns to the calling program, allowing the user to retrace the form identifier 30.

If it is determined in step 206 that the strin31 31g stored in step 204 was not recorded within the form identification area 82 of the digitizer pad 12, it is determined in step 224 whether this string was recorded within an area reserved for the termination character 42 to provide an indication that the user has completed the process of filling out an individual form. If the character string is determined to be in this area, an additional determination is made in step 226 of whether the character string is the particular character that has been chosen for this purpose. If it is not, an error message is displayed on the display 18 in step 228 as the system returns to the calling program in step 216, allowing the user to make further corrections as needed.

If it is determined in step 226 that the termination character 42 has been recognized, a coordinate system is established in step 230 for the form that has been filled out, with this coordinate system being established to relate positions on the digitizer pad 12 with the strokes resulting from tracing the identifier 30 and the termination character 42. If the form 14 has not slipped on the surface above the digitizer pad 12 between the tracing of the identifier 30 and the tracing of the termination character 42, the coordinate system established in step 230, should accurately establish coordinates for each character string stored during previous passes through step 204. If the form 14 has slipped on the surface above the digitizer pad 12 between these tracing processes, the new coordinate system is still positioned according to a point midway between the location on the digitizer pad 12 where the identifier 30 was traced and a location on the digitizer pad 12 where the termination character 42 was traced, so that the maximum errors in the placement of character strings is reduced.

After the coordinate system is established in step 230, a determination is made in step 232 of whether the form identification flag has been written in the previous step 222. If it has not been set, it is known that data indicating the location of fields for input data on the form has been stored within the input form data structure 67, so each string stored for this form 14 in previous passes through step 24 is recorded in step 234 for display in the nearest data field described in this data structure 67, with the location of the entered data being established using the coordinate system established in step 230. This input form data, from the second field 70 of the input form data structure 67, is used to locate the codes for character strings for subsequent processing. For example, name data entered into the form may be stored in a name data field for subsequent processing, such as arranging the data from a number of forms in alphabetic order according to the names for easy retrieval of the information.

Thus, according to the third embodiment of the invention correspondence between locations determined according to the formatting data stored in the second field 70 of the input form data structure 67 and associated with the format identifying data pattern representing the pattern of movement of the stylus within the form identifying area 82 and the locations of the data range boxes on the form 14 is established according to a placement of the format identifying pattern 30 and further according to a placement of the termination pattern 42.

On the other hand, if it is determined in step 232 that the form identification flag has not been written, it is known that input data on the form has not been stored within the input data structure, so that the locations of data fields for this form are not known, and that this step 234 must be skipped. In either case, the system then proceeds to step 236, in which a determination is made of whether there are coordinate issues that need to be resolved in postprocessing 188. Such issues may result, for example, from a change in the relative positions of the identifier 30 and the termination character 42, or from an inability to place one or more character strings in an appropriate data field in step 234. If one or more of such issues are found a coordinate flag bit is written in step 238 to the flag field 87 of the entry 84 of the output form data structure 71 for this form, so that a need for additional attention in postprocessing is identified.

Then, in step 240, a determination is made of whether non-character data, such as strokes forming portions of a drawing instead of characters, is included in the form presently being processed. If it is, such data is written in step 242 to locations established within the coordinate system established in step 230.

Preferably, the data provided as inputs to this form by the user is next displayed in step 244, along with input data for this form from the input form data structure 67, if such data is available. Then, the user indicates whether he approves of the completed form, for example, by using the buttons and switches 24. If it is determined in step 246 that the user has not approved the form, the system returns to the calling program 216, allowing the user to continue adding data or to make corrections as desired. If it is determined in step 246 that the user has approved the form, the completion flag is written in the entry 84 corresponding to the form to the flag field 87 of the output form data structure 71 before the system returns to the calling program in step 216 to allow, for example, the process of filling out another form to begin.

Since individual character boxes 32 within data fields 34 are not used in the third embodiment of the invention, the markings for such boxes 32 may be eliminated from the indicia printed on the form 14. Alternately, markings for such boxes 32 may be present to guide the user in the spacing of characters so that the accuracy of the recognition process is improved.

While the third embodiment of the invention has been described as being implemented in the apparatus of FIG. 1, it is understood that this embodiment of the invention can also be implemented in the apparatus of FIG. 6, using a digitizer pad underlying the form, with a principle difference being the limitations imposed on the amount of material being displayed on the smaller display screen 162. It is also understood that this embodiment of the invention can be implemented using a pattern 176 printed on the form to develop position information, with a principle difference being the elimination of steps 226 through 238, so that the system proceeds from a determination that the right termination character has been recognized in step 226 to a determination of whether non-character data is included in the form in step 240. This is possible because there is no way for the printed form to slip relative to a coordinate system provided by the markings 176.

While the invention has been described in its preferred versions or embodiments with some degree of particularity, it is understood that this description has been given only by way of example, and that many variations can be made without departing from the spirit and scope of the invention.

What is claimed is:

1. In a computer system having a user interface including a stylus for marking surfaces of markable media and location sensing means for detecting locations of said stylus as said stylus is moved along a surface of said markable media, a method for selecting a format for placement of data derived from said location sensing means, wherein said method comprises:
sensing a format identifying pattern of movement of said stylus along a markable medium within a format identifying area of said markable medium;
generating a format identifying data pattern representing said format identifying pattern of movement of said stylus; and
searching a data structure including a plurality of format identifying data patterns and formatting data associated with each of said format identifying data patterns for a match between said format identifying data pattern representing said pattern of movement of said stylus and a format identifying data pattern within said plurality of format identifying data patterns.

2. The method of claim 1, wherein
said markable medium includes visible indicia forming a visible pattern within said format identifying area, and
tracing said visible pattern with said stylus moves said stylus in said format identifying pattern of movement of said stylus.

3. The method of claim 2, wherein each of said format identifying data patterns comprises a sequence of characters.

4. A method for processing input data provided through a computer system user interface including a stylus for marking surfaces of markable media and location sensing means for detecting locations of said stylus as said stylus is moved along a surface of said markable media, wherein said method comprises:
sensing a plurality of input patterns of movement of said stylus along said markable medium in an area outside a termination identifying area of said markable medium;
generating a data input structure representing each of said input patterns of movement of said stylus;
storing each said data input structure;
sensing a termination pattern of movement of said stylus along said markable medium in said termination identifying area of said markable medium; and
after sensing said termination pattern of movement of said stylus along said markable medium, transmitting each said data input structure for processing.

5. The method of claim 4, wherein each said data input structure is transmitted for processing in response to sensing said termination pattern of movement of said stylus.

6. The method of claim 4, wherein said markable medium includes visible indicia forming a visible pattern within said termination identifying area, and
tracing said visible pattern with said stylus moves staid stylus in said termination pattern of movement of said stylus.

7. The method of claim 6, wherein said termination pattern of movement of said stylus is recognized as a character.

8. The method of claim 4, wherein
sensing said plurality of input patterns of movement is preceded by:
sensing a format identifying pattern of movement of said stylus along said markable medium within a format identifying area of said markable medium;
generating a format identifying data pattern representing said format identifying pattern of movement of said stylus; and
searching a data structure including a plurality of format identifying data patterns and formatting data associated with each of said format identifying data patterns for a match between said format identifying data pattern representing said pattern of movement of said stylus and a format identifying data pattern within said plurality of format identifying data patterns, and
each said data input structure is located for processing according to said formatting data associated with said format identifying data pattern representing said pattern of movement of said stylus.

9. The method of claim 8, wherein
said markable medium includes visible indicia forming a visible pattern within said format identifying area, and
tracing said visible pattern with said stylus moves said stylus in said format identifying pattern of movement of said stylus.

10. The method of claim 8, wherein each said data input structure is located for processing according to said formatting data associated with said format identifying data pattern representing said pattern of movement of said stylus after sensing said termination pattern of movement of said stylus along said markable medium.

11. The method of claim 8, wherein
said data input structure representing each of said input patterns of movement of said stylus includes representations of a number of strings of characters, and
said markable medium includes visible indicia forming a visible pattern of data range boxes surrounding locations for marking written representations of said strings of characters.

12. The method of claim 11, wherein said locations determined according to said formatting data associated with said format identifying data pattern representing said pattern of movement of said stylus correspond to locations of said data range boxes on said markable medium.

13. The method of claim 8, wherein correspondence between said locations determined according to said formatting data associated with said format identifying data pattern representing said pattern of movement of said stylus and said locations of said data range boxes on said markable medium is established according to a placement of said format identifying pattern of movement of said stylus and further according to a placement of said termination pattern of movement of said stylus.

14. A method for processing input data provided through a computer system user interface including a stylus for marking surfaces of markable media and location sensing means for detecting locations of said stylus as said stylus is moved along a surface of said markable media, wherein said method comprises:
sensing a format identifying pattern of movement of said stylus along said markable medium within a format identifying area of said markable medium;
generating a format identifying data pattern representing said format identifying pattern of movement of said stylus; and
searching a data structure including a plurality of format identifying data patterns and formatting data associated with each of said format identifying data patterns for a match between said format identifying data pattern representing said pattern of movement of said stylus and a format identifying data pattern within said plurality of format identifying data patterns,
sensing a plurality of input patterns of movement of said stylus along said markable medium in an area outside a termination identifying area of said markable medium;
generating a data input structure representing each of said input patterns of movement of said stylus; and
storing each said data input structure in a location for processing according to said formatting data associated with said format identifying data pattern representing said pattern of movement of said stylus.

15. The method of claim 14, wherein each said data input structure is stored in said location for processing before generating another data input structure.

16. The method of claim 14, additionally comprising displaying data representing said input patterns of movement of said stylus in locations determined according to said formatting data associated with said format identifying data pattern representing said pattern of -movement of said stylus.

17. The method of claim 14 wherein each of said format identifying data patterns comprises a sequence of characters.

18. The method of claim 17, wherein
said data input structure representing each of said input patterns of movement of said stylus includes encoded representations individual characters, and
said markable medium includes visible indicia forming a visible pattern of character boxes surrounding locations for marking written representations of said individual characters.

19. The method of claim 18, wherein said locations determined according to said formatting data associated with said format identifying data pattern representing said pattern of movement of said stylus correspond to locations of said character boxes on said markable medium.

20. Apparatus comprising:
a markable medium having an upper surface including a format identifying area;
a stylus having a point visibly marking said markable medium as said point is slid along said upper surface of said markable medium;
location sensing means providing a stylus location signal representing locations of said point as said point is slid along said upper surface of said markable medium;
data storage including and output data structure and an input data structure having a plurality of format identifying data patterns and formatting data associated with each of said format identifying data patterns;
processor means programmed to
generate input data patterns representing movement of said stylus along said upper surface in response to said stylus location signal, wherein said input data patterns include a format identifying data pattern representing movement of said stylus along said upper surface within said format identifying area,
search said input data structure for a match between said format identifying data pattern representing movement of said stylus along said upper surface within said format identifying area and a format identifying data pattern stored within said input data structure; and
store said input data for processing in locations according to said formatting data associated with said format identifying data pattern stored within said input data structure and associated with said format identifying data pattern representing movement of said stylus along said upper surface within said format identifying area.

21. The apparatus of claim 20, wherein
said upper surface of said markable medium additionally includes visible indicia forming a visible pattern within said format identifying area, and
tracing said visible pattern with said stylus moves said stylus in said format identifying pattern.

22. The apparatus of claim 20, wherein
said location sensing means includes a digitizer pad extending under said markable medium, and
said stylus includes circuits interacting with said digitizer pad to form a signal indicating a path of movement of said stylus along said markable medium.

23. The apparatus of claim 20, wherein
said markable medium additionally includes markings extending across said upper surface, and
said location sensing means includes a camera unit within said stylus reading said markings extending across said upper surface and a circuit generating a single indicating locations of said stylus on said upper surface in response to an output of said camera unit.

24. The apparatus of claim 20, wherein
said upper surface of said markable medium additionally includes a termination identifying area, and
said processor means is additionally programmed to:
sense a termination pattern of movement of said stylus along said markable medium along said termination identifying area; and
transmit said input data patterns for processor after sensing said termination pattern of movement of said stylus.

25. The apparatus of claim 21, wherein
said upper surface of said markable medium includes termination indicia within said termination area describing said termination pattern, and
tracing said termination pattern causes said stylus to move in said termination pattern.

26. A computer readable medium having recorded thereon program instructions causing a processor within a computing system having a user interface including a stylus for marking a surface of markable media and location sensing means for generating a stylus location signal indicating locations of said stylus as said stylus is moved along a surface of said markable media to:
generate input data patterns representing movement of said stylus along an upper surface of said markable medium in response to said stylus location signal, wherein said input data patterns include a format identifying data pattern representing movement of said stylus along said upper surface within a format identifying area,
search an input data structure for a match between said format identifying data pattern representing movement of said stylus along said upper surface within said format identifying area and a format identifying data pattern stored within said input data structure; and
store said input data for processing in locations according to formatting data associated with said format identifying data pattern stored within said input data structure and associated with said format identifying data pattern representing movement of said stylus along said upper surface within said format identifying area.

27. The computer readable medium of claim 26, wherein said program instructions additionally program said processor to:
sense a termination pattern of movement of said stylus along said markable medium within a termination identifying area; and
transmit said input data patterns for processor after sensing said termination pattern of movement of said stylus.

28. A computer data signal embodied in a carrier wave, comprising program instructions causing a processor within a computing system having a user interface including a stylus for marking a surface of markable media and location sensing means for generating a stylus location signal indicating locations of said stylus as said stylus is moved along a surface of said markable media to:
generate input data patterns representing movement of said stylus along an upper surface of said markable medium in response to said stylus location signal, wherein said input data patterns include a format identifying data pattern representing movement of said stylus along said upper surface within a format identifying area,
search an input data structure for a match between said format identifying data pattern representing movement of said stylus along said upper surface within said format identifying area and a format identifying data pattern stored within said input data structure; and
store said input data for processing in locations according to formatting data associated with said format identifying data pattern stored within said input data structure and associated with said format identifying data pattern representing movement of said stylus along said upper surface within said format identifying area.

29. The computer data signal of claim 28, wherein said program instructions additionally program said processor to:
sense a termination pattern of movement of said stylus along said markable medium within a termination identifying area; and
transmit said input data patterns for processor after sensing said termination pattern of movement of said stylus.
